(19) United States
(12) Patent Application Publication
(10) Pub. No.: US 2021/0329864 A1
(43) Pub. Date: Oct. 28, 2021

(54) MANIFOLD FOR BIOREACTOR

(71) Applicant: Hypergiant Industries, Inc., Austin, TX (US)

(72) Inventors: Benjamin Edward Lamm, Dallas, TX (US); Andrew Thomas Busey, Austin, TX (US); Daniel David Haab, Austin, TX (US); Davis Michael Saltzgiver, Austin, TX (US); Willem Vonk, Austin, TX (US)

(21) Appl. No.: 17/237,227

(22) Filed: Apr. 22, 2021

Related U.S. Application Data
(60) Provisional application No. 63/014,504, filed on Apr. 23, 2020.

(51) Int. Cl. A01G 33/00; A01G 7/04; A01G 7/02

(52) U.S. Cl. CPC A01G 33/00; A01G 7/02; A01G 7/045

(57) ABSTRACT

A photobioreactor apparatus is described. The photobioreactor provides a system for growth of biological organisms such as algae. The photobioreactor system includes a plurality of transparent conduits coupled between two manifolds. Fluid and feedstock are flowed through the conduits and light is provided at a growth wavelength for growth of biological organisms in the conduits. The manifolds may include passages that allow the fluid and feedstock to flow linearly through the conduits (e.g., from one conduit to the next). The linear or series flow of the fluid and feedstock through the plurality of conduits provides an efficient and cost-effective approach for growth of biological organisms.

### PRIORITY CLAIM

This patent application claims priority to U.S. Provisional Patent Application No. 63/014,504, filed Apr. 23, 2020, which is incorporated by reference as if fully set forth herein.

### BACKGROUND

### 1. Field of the Invention

The present disclosure relates generally to devices for producing biological organisms. More particularly, embodiments disclosed herein relate to devices, such as photobioreactors, that support the production of microorganisms such as algae.

### 2. Description of Related Art

Photobioreactors are reactors that utilize a light source to support the growth of phototrophic microorganisms in a controlled, artificial environment. Photobioreactors may be used to support photosynthetic growth of various different organisms using carbon dioxide and light. Examples of organisms that have been grown using photobioreactors include algae (e.g., macroalgae and/or microalgae), plants, mosses, cyanobacteria, and purple bacteria.

### BRIEF DESCRIPTION OF THE DRAWINGS

Features and advantages of the methods and apparatus of the embodiments described in this disclosure will be more fully appreciated by reference to the following detailed description of presently preferred but nonetheless illustrative embodiments in accordance with the embodiments described in this disclosure when taken in conjunction with the accompanying drawings in which:

FIG. 1 depicts an isometric view of an embodiment of a bioreactor.

FIG. 2 depicts an exploded isometric view of an embodiment of a bioreactor showing components of a top manifold and a bottom manifold.

FIG. 3 depicts an enlarged, exploded isometric view of an embodiment of the components in a top manifold.

FIG. 4 depicts an enlarged, exploded isometric view of an embodiment of the components in a bottom manifold.

FIG. 5 depicts an enlarged, exploded isometric view of an embodiment of the components in a bottom manifold that is rotated 180° from the view depicted in FIG. 4.

FIG. 6 depicts an exploded perspective view of an embodiment of a bioreactor showing fluid flow.

### DETAILED DESCRIPTION OF EMBODIMENTS

Photobioreactors are used as controlled, artificial environments for the growth of microorganisms. As used herein, a “photobioreactor” refers to reactor that utilizes a light source to promote growth of phototrophic microorganisms. In many instances, photobioreactors support photosynthetic growth of microorganisms in a fluid using carbon dioxide and light. Microorganisms that may be grown in photobioreactors include, but are not limited to, algae (e.g., macroalgae and/or microalgae), plants, mosses, cyanobacteria, and purple bacteria.

Photobioreactors can include either open systems or closed systems. Open systems are typically used for producing phototrophic organisms on an industrial scale. Open systems, however, require large areas and large water sources and may have limited productivity rates and high losses due to water evaporation. Closed systems may provide more controllable growth. Closed systems, however, may be more expensive or more difficult to operate for producing phototrophic organisms on an industrial scale.

The present inventors have realized that improvements in a closed photobioreactor system can be made to increase the production scale for closed systems to closer to industrial scale levels. For instance, improvements in a closed system are possible to produce phototrophic microorganisms more efficiently and more cost-effectively. The present disclosure recognizes that closed system bioreactors that grow algae (or other biological organisms) as quickly as possible are desirable for many uses, including potential industrial scale uses. For example, a closed system bioreactor may have a large surface area for growing biological organisms in a small footprint. Additionally, the present disclosure recognizes that it is desirable to control factors including light, available carbon dioxide, temperature, biodensity, and harvest cycle in closed system bioreactors.

One embodiment described herein has four broad components: 1) a plurality of transparent conduits, 2) a light source to provide light at a wavelength suitable for growing biological organisms, 3) a first manifold having openings that receive first ends of the conduits, and 4) a second manifold having openings that receive second ends of the conduits. In certain embodiments, the first manifold and the second manifold include passages that are in fluid communication with the openings in the manifolds. The passages may allow fluid to flow linearly through the conduits between an inlet coupled to a first conduit and an outlet coupled to a last conduit. In various embodiments, the first passages and the second passages are aligned such that fluid enters the apparatus through the first conduit, flows through the conduits in series, and exits the apparatus through the last conduit. In some embodiments, a reservoir is coupled to the conduits. The reservoir provides fluid and feedstock for growth of biological organisms to the conduits. In various embodiments, a mass of biological organisms produced in the conduits is harvested from the conduits after a period of time.

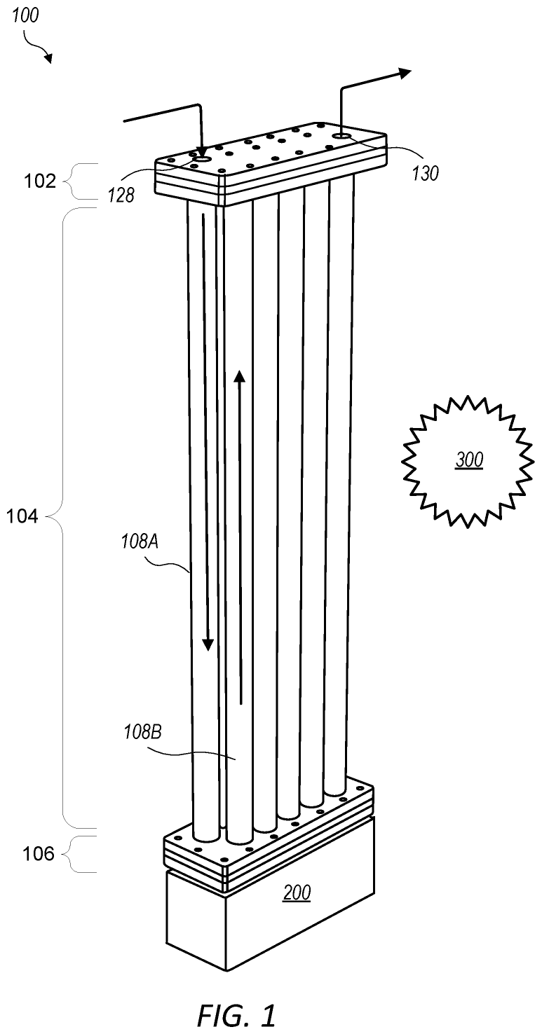

FIG. 1 depicts a perspective view of an embodiment of bioreactor 100. In certain embodiments, bioreactor 100 is a modular bioreactor. A modular bioreactor 100 may, for example, be coupled to one or more additional bioreactors to form up a larger bioreactor. In such embodiments, bioreactor 100 includes connections that allow multiple bioreactors to be coupled together. In some contemplated embodiments, multiple bioreactors 100 are coupled together in series to form a single, larger bioreactor with single output of organisms. In other contemplated embodiments, multiple bioreactors 100 are coupled together in parallel to provide multiple parallel outputs of organisms.

In the illustrated embodiment, bioreactor 100 includes top manifold 102, tube section 104, and bottom manifold 106. Tube section 104 may include a plurality of tubes 108 coupled between top manifold 102 and bottom manifold 106. Tubes 108 may be made of glass, plastic, or any other material that is substantially transparent to a desired spectrum of light (e.g., a visible spectrum light). Top manifold 102 and bottom manifold 106 may direct (e.g., route) the flow of fluid through tubes 108 (e.g., direct fluid flow from one tube to the next).

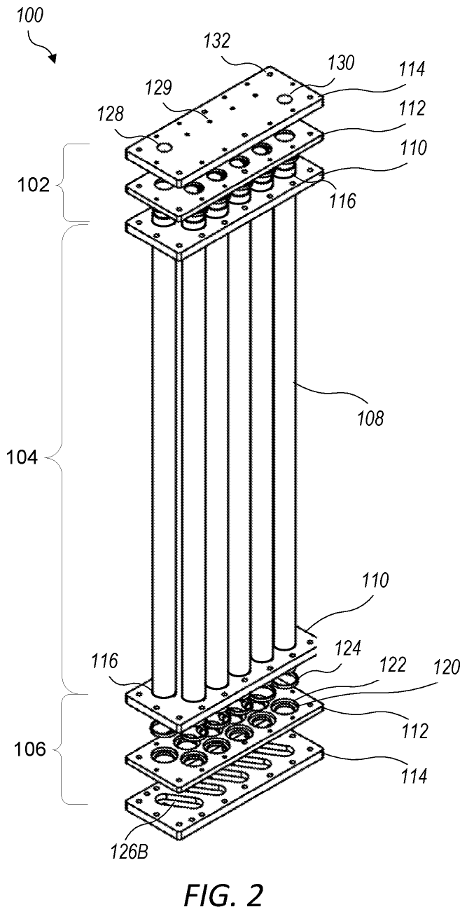

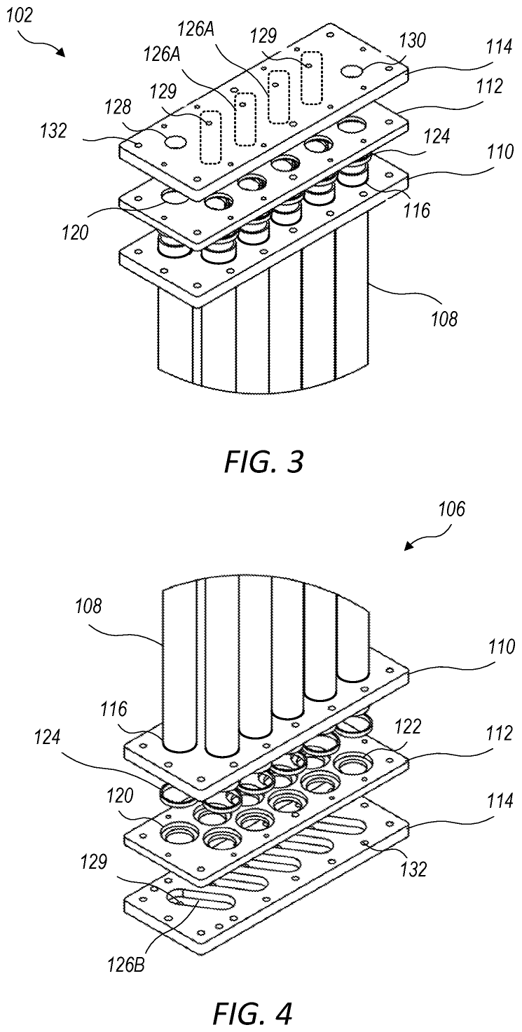

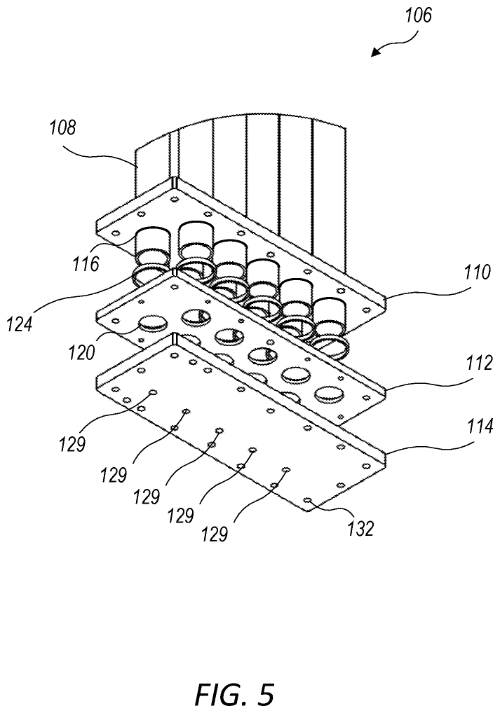

FIG. 2 depicts an exploded isometric view of an embodiment of bioreactor 100 showing components of top manifold 102 and bottom manifold 106. FIG. 3 depicts an enlarged, exploded isometric view of an embodiment of the components in top manifold 102. FIG. 4 depicts an enlarged, exploded isometric view of an embodiment of the components in bottom manifold 106. FIG. 5 depicts an enlarged, exploded isometric view of an embodiment of the components in bottom manifold 106 that is rotated 180° from the view depicted in FIG. 4. In certain embodiments, the components of top manifold 102 and bottom manifold 106 include capture plates 110, guide plates 112, and interface plates 114.

As shown in FIGS. 2-5, ends of tubes 108 may be inserted through capture plates 110 in both top manifold 102 and bottom manifold 106. Tubes 108 can be inserted through holes 116 in capture plates 110. Holes 116 may be sized such that tubes 108 have a substantially secure fit (e.g., tight fit) within the holes.

After tubes 108 pass through capture plates 110, the tubes may be inserted through holes 120 in guide plates 112. In certain embodiments, guide plates 112 include recesses 122 at holes 120 (as shown in FIGS. 2 and 4). Recesses 122 may be shaped to seat o-rings 124 in guide plates 112. O-rings 124, when seated in recesses 122, may form a seal between the outside surface of tubes 108 and the surfaces of guide plates 112 as the tubes pass through the guide plates. The seal formed may inhibit fluid moving between adjacent tubes 108 in interface plates 114 (as described below) from leaking outside the manifolds. Friction between tubes 108 and o-rings 124 along with friction between the o-rings and the plates may hold the tubes within the manifolds. Using only friction to hold tubes 108 in place may allow the tubes to be removed for maintenance and/or replacement, as described herein. In some embodiments, holes 116 and/or holes 120 may be sized to allow for variations in the diameter of tubes 108. Tubes 108 can have variations in diameter due to variances in manufacturing of the tubes. Thus, holes 116 and/or holes 120 may be sized to accommodate such manufacturing variances.

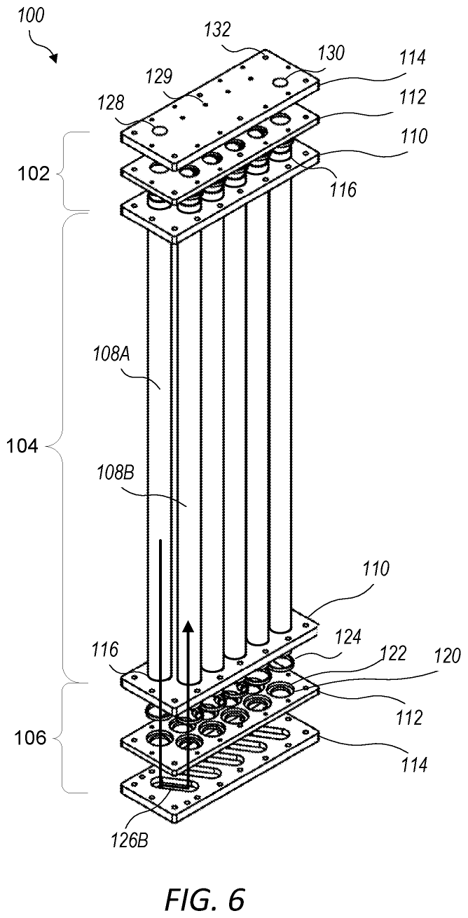

Ends of tubes 108 may be positioned in recesses 126 in interface plates 114. For example, at least a portion of tubes 108 are placed within recesses 126. Recesses 126 may be grooved recesses or other indentions in interface plates 114 that act as passages to allow fluid communication between two tubes 108 when the ends of the tubes are positioned in the recesses. As such, fluid may flow out an end of a first tube and into the end of a second tube when the ends of the tubes are positioned in recesses 126 (e.g., flow is directed from one tube to the next tube by the recesses). FIG. 6 depicts an exploded perspective view of an embodiment of bioreactor 100 showing fluid (represented by the arrow) exiting tube 108A, moving through recess 126, and going up tube 108B.

In certain embodiments, recesses 126A (shown by dashed lines in FIG. 3) in top manifold 102 and recesses 126B (shown in FIGS. 2 and 4) in bottom manifold 106 are oriented in opposing directions such that fluid flow is directed through tubes 108 in series (e.g., sequentially from one tube to the next) between inlet 128 and outlet 130. For example, recesses 126A and recesses 126B may be oriented perpendicular or close to perpendicular with respect to each other. Orienting recesses 126A and recesses 126B in this manner may direct fluid in a single direction through each of tubes 108 between inlet 128 and outlet 130. Thus, as shown by the arrows in FIG. 1, fluid may enter bioreactor 100 at inlet 128, go down first tube 108A, then up second tube 108B, and continue this pattern to outlet 130. Directing fluid through each of tubes 108 may route the fluid in a linear way and make one continuous flow path for fluid through the tubes. Providing the one continuous flow path through tubes 108 in bioreactor 100 may maximize the surface area in contact with the fluid in the bioreactor for the growth of biological organisms in the bioreactor.

While the embodiment of bioreactor 100 shown in FIGS. 1-5 depicts tubes 108 arranged in a series configuration (flow from one tube to the next), other embodiments may be contemplated where tubes 108 are arranged in a parallel configuration. For example, recesses 126 in top manifold 102 and/or bottom manifold 106 may be positioned such that tubes 108 are coupled to a tank, harvester, or other external apparatus in parallel. Connecting tubes 108 in parallel may provide direct feedback between the external apparatus and the tubes.

In various embodiments, routing fluid through inlet 128, tubes 108, and outlet 130, as shown in FIG. 1, may provide modularity for the design of bioreactor 100 and allow the bioreactor to be coupled to one or more additional bioreactors as part of a group of bioreactors. In certain embodiments, both inlet 128 and outlet 130 are positioned in a single manifold (e.g., top manifold 102). For example, with an even number of tubes 108, inlet 128 and outlet 130 may be positioned in the same manifold. Other embodiments with odd numbers of tubes may also be contemplated. In embodiments with odd numbers of tubes 108, inlet 128 and outlet 130 may be positioned in different manifolds (e.g., the inlet is in top manifold 102 and the outlet is in bottom manifold 106).

In certain embodiments, capture plates 110, guide plates 112, and interface plates 114 are made of high-density materials that inhibit leaking. For example, in some embodiments, capture plates 110, guide plates 112, and interface plates 114 are made of polycarbonate and/or HDPE (high-density polyethylene). In some embodiments, capture plates 110, guide plates 112, and interface plates 114 are made of metals such as, but not limited to, aluminum. Using metal materials may provide more rigidity and reduce chances for breakage and/or leakage from the manifolds.

In certain embodiments, capture plates 110, guide plates 112, and interface plates 114 may be held together using fasteners 132. Fasteners 132 may be, for example, screws, bolts, or other fastener devices. Fasteners 132 may be distributed around the edges of the plates to distribute the clamping forces around the plates. In some embodiments, capture plates 110, guide plates 112, and interface plates 114 may be held together using a clamp-type device. The clamp-type device may include one or more latches to secure the plates together. The latches may allow the plates to be repeatably secured and unsecured for cleaning and/or other operations (e.g., removal of broken tubes from the manifolds). In some embodiments, the plates are hinged (e.g., the plates may be hinged together on one side of the plates). Hinging the plates may allow the plates to be opened and closed without separation of the plates.

In certain embodiments, one or more gaskets (or another sealing material) are placed between the plates to provide a seal inhibiting fluid leakage from the manifolds. Gaskets may be used, for example, in combination with fasteners 132 and/or latches to provide sealing when the plates are secured together. In some embodiments, a sealant material (e.g., silicone) may be used to provide additional protection against leaks from the manifolds. For example, the sealant material may be placed around the outside of the manifold to prevent leakage of fluid therefrom.

In certain embodiments, interface plates 114 include drain holes 129. Drain holes 129 may be aligned and in fluid communication with recesses 126. Drain holes 129 may provide fluid access to tubes 108 through recesses 126. In some embodiments, bleed valves or drain valves may be coupled to drain holes 129. For example, bleed valves may be coupled to drain holes 129 in a manifold to bleed off gas (e.g., air) as tubes 108 are filled with fluid (e.g., water). Bleeding off gas may equalize pressure in tubes 108 as the tubes are filled and ensure proper filling of the tubes with fluid without trapping gas in the tubes. For example, in one embodiment, gas (air) may be pushed out of tubes 108 as fluid fills the tubes. In another embodiment, a pump or other suction device may be coupled to drain holes 129 to pull gas from the tubes until fluid fills up the tubes and begins to be drawn out through the drain holes. In some embodiments, drain valves may be coupled to drain holes 129 in a manifold to drain tubes 108 as needed. Providing individual drain holes 129 may provide for more controlled bleeding or draining of tubes 108.

In some embodiments, one or more components in top manifold 102 or bottom manifold 106 are integrated into a single component. For example, capture plates 110 and guide plates 112 may be integrated into a single component with o-rings 124 positioned inside the single component. In some embodiments, top manifold 102 or bottom manifold 106 may include access ports to access tubes 108. For example, a manifold may have screw caps at the positions of drain holes 129. The screw caps may be removable from the manifold to provide access to tubes 108. Seals may prevent leakage around the screw caps when in place on the manifold.

In some embodiments, one or more sensors are included in top manifold 102 or bottom manifold 106. Sensors may be used to assess operating properties of bioreactor 100. Operating properties assessed may include, but not be limited to, flow rate, temperature, pressure, pH, and photon detection. In some embodiments, sensors may be provided into tubes using the access ports described above. In some embodiments, sensors may be placed in a secondary reservoir attached to tubes 108 (e.g., a reservoir in utility system 200, described below).

The structures of top manifold 102 and bottom manifold 106 may also provide the ability for more simple cleaning and maintenance of bioreactor 100. For instance, a manifold may be opened (such as by opening the latches) to provide access to tubes 108 for cleaning or replacement of the tubes. If the manifold is permanently sealed (e.g., is sealed with silicone), the manifold may be removed to provide access for cleaning or replacement of tubes and may then be replaced with a new manifold.

Bioreactor 100 may be used to grow different types of biological organisms. In certain embodiments, bioreactor 100 is used to grow algae. The algae may include macroalgae and/or microalgae. Other biological organisms that may be grown using bioreactor 100 include, but are not limited to, plants, mosses, and bacteria (e.g., cyanobacteria or purple bacteria). Top manifold 102 and bottom manifold 106 provide structures that hold tubes 108 as close together as possible to produce a small footprint for bioreactor 100. In certain embodiments, tubes 108 have an average spacing between the tubes of at most about 0.5 inches. As used herein, “average spacing” refers to an average of the distances between outside walls of tubes 108 in bioreactor 100. The average spacing between tubes 108 may, however, vary. For example, larger spacings may be implemented to accommodate additional hardware or equipment in spaces between tubes 108 (such as hardware to allow the tubes to be more easily removable). In some embodiments, tubes 108 may have an average spacing between the tubes of between about 0.25 inches and about 0.5 inches, between about 0.25 inches and about 0.75 inches, or between about 0.1 inches and about 1.5 inches.

In some embodiments, tubes 108 have a length that varies between about 30 inches and about 70 inches. For example, tubes 108 may have a length of about 48 inches. Other lengths of tubes 108 may, however, also be contemplated depending on the requirements for growth of biological organisms in bioreactor 100. In some embodiments, tubes 108 have diameters that vary between 0.5 inches and 1.5 inches. In one embodiment, tubes 108 have diameters of 0.75 inches. Diameters of tubes 108 may also vary depending on the requirements for growth of biological organisms in bioreactor 100. For example, the lengths or diameters of tubes 108 may vary based on biological requirements that may be algae strain dependent.

The embodiment of bioreactor 100 illustrated in FIGS. 1-5 is a modular bioreactor that includes a high density of tubes 108 in a low-cost structure. Utilizing tubes 108 in bioreactor 100 provides an efficient way to grow biological organisms by increasing the surface area per volume of fluid that the organisms are growing in as compared to other typical bioreactors (e.g., open bioreactors). Increasing the surface area per volume of fluid using tubes 108 in a dense configuration may also provide a large amount of surface area for growth of biological organisms in a relatively small footprint. For example, in one embodiment, bioreactor 100 with ten tubes in a footprint of (6 inches×15 inches×48 inches) may have a combined light exposed surface area of about 2262 square inches and a combined volume of about 848 cubic inches, which gives about 4400 square inches of exposed algae per cubic foot. A rectangular volume bioreactor having the same footprint may only have an exposed surface area of about 2016 square inches with a volume of about 4320 cubic inches, which gives only about 1692 square inches of exposed algae per cubic foot. Thus, bioreactor 100 may provide a larger exposed algae area per cubic foot. In some embodiments, bioreactor 100 may have a surface area of exposed algae per cubic foot of at least about 2500 square inches per cubic foot, at least about 3000 square inches per cubic foot, at least about 4000 square inches per cubic foot, or at least about 5000 square inches per cubic foot. The surface area per cubic foot volume of the bioreactor may be varied by using longer or shorter tubes 108 or different diameter tubes to provide more surface area (longer tubes) or less surface area (shorter tubes) as desired.

Having multiple tubes 108 operating in series (as described above) in bioreactor 100 also may increase the efficiency of light energy (e.g., photons) reaching the growing biological organisms in the bioreactor. As such, bioreactor 100 provides an efficient biological organism growth apparatus in a small and modular size. The number of tubes 108 in bioreactor 100 may also be varied to produce different sizes of reactor modules as desired. Additionally, the modularity of bioreactor 100 may allow the bioreactor to be combined with additional bioreactor modules to form larger bioreactors.

In the illustrated embodiment of FIG. 1, utility system 200 is positioned near or coupled to a manifold in bioreactor 100. In certain embodiments, utility system 200 is attached to or positioned in a structure (e.g., a housing or cabinet) used to support the manifolds and tubes to provide a modular system for the bioreactor. Utility system 200 may include devices and/or apparatus that are used to facilitate growth of biological organisms in bioreactor 100. Examples of devices and/or apparatus included in utility system include, but are not limited to, fluid circulators (e.g., pumps), reservoirs (e.g., tanks), sensors, gas sources, nutrient (feedstock or raw material) feeders, and cleaning devices.

In certain embodiments, a reservoir in utility system 200 is in fluid communication with tubes 108 (e.g., through inlet 128 on a manifold (such as top manifold 102)). The reservoir may be a source of fluid and feedstock used for the growth of biological organisms in tubes 108. In some embodiments, a fluid circulator (e.g., a pump) is coupled to or placed in the reservoir. The fluid circulator may move fluid and feedstock to tubes 108 from the reservoir. In some embodiments, the reservoir may be an open-air reservoir that allows carbon dioxide to be pulled from the surrounding air.

In certain embodiments, utility system 200 includes a harvester. The harvester may, for example, be coupled to outlet 130 on a manifold (such as top manifold 102) and be in fluid communication with tubes 108 through the outlet. The harvester may be used to harvest biomass (e.g., a mass of biological organisms) grown from tubes 108.

In certain embodiments, utility system 200 is coupled to inlet 128 and outlet 130 on a manifold (e.g., top manifold 102). Tubes or valves may be used to couple utility system 200 to the manifold. In some embodiments, pumps or other fluid circulators in utility system provide pressure to create mixed flow in tubes 108 (e.g., mixing of biomass and fluid in the tubes). Mixing in tubes 108 may be used to inhibit settling of biomass in recesses 126 in the manifolds or to promote growth of biomass in the tubes.

In certain embodiments, bioreactor 100 includes light source 300. Light source 300 may be any light source capable of providing light in wavelengths suitable for growth of a desired biological organism in bioreactor 100. For example, light source 300 may provide light at visible wavelengths, UV wavelengths, near-UV wavelengths, or combinations thereof. Thus, light source may provide light at wavelengths between 100 nm and 700 nm or smaller ranges therein. In some embodiments, light source 300 is fluorescent lights or LED lights capable of visible, UV, or near-UV radiation. In some embodiments, light source 300 is attached or included as part of a structure (e.g., a housing or cabinet) used to support the manifolds and tubes of bioreactor 100. In some embodiments, light source 300 is external to the structure used to support the manifolds and tubes of bioreactor 100.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first conduit,” “second conduit,” “particular conduit,” “given conduit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U. S.C. § 112(f) for that claim element. Should Applicant wish to invoke Section 112(f) during prosecution of a United States patent application based on this disclosure, it will recite claim elements using the “means for” [performing a function] construct.

What is claimed is:

1. An apparatus for growing biological organisms, comprising:
a plurality of transparent conduits;
a light source configured to provide light at a wavelength between 100 nm and 700 nm;
a first manifold having a plurality of first openings configured to receive first ends of the conduits;
a second manifold having a plurality of second openings configured to receive second ends of the conduits; and
a reservoir in fluid communication with the conduits, wherein the reservoir is configured to provide fluid and feedstock for growth of biological organisms to the conduits;
wherein the first manifold includes a plurality of first passages and the second manifold includes a plurality of second passages, the first passages being in fluid communication with the first openings in the first manifold and the second passages being in fluid communication with the second openings in the second manifold, and wherein the first and the second passages are configured to allow fluid to flow in series through the plurality of conduits between an inlet coupled to a first conduit in the plurality of conduits and an outlet coupled to a last conduit in the plurality of conduits.

2. The apparatus of claim 1, wherein the first manifold includes a first plate comprising the first passages and at least one additional plate comprising the first openings that are coupled together to secure the first ends of the plurality of conduits to the first manifold, wherein the first passages in the first plate are aligned with a pair of the first openings in the at least one additional plate.

3. The apparatus of claim 1, wherein at least one of the first passages is in fluid communication with a pair of the first openings.

4. The apparatus of claim 3, wherein the at least one of the first passages is configured to provide fluid flow between ends of a pair of conduits received in the pair of the first openings.

5. The apparatus of claim 1, wherein the passages are grooved recesses in the manifolds that are aligned in parallel.

6. The apparatus of claim 1, wherein the inlet is coupled to one of the first openings in the first manifold that is configured to receive the first conduit, and wherein the outlet is coupled to one of the first openings in the first manifold that is configured to receive the last conduit.

7. The apparatus of claim 1, further comprising one or more seals in the first and second manifolds, wherein the seals are configured to be positioned around the ends of the conduits received in the manifolds to inhibit leakage of fluid from the manifolds.

8. The apparatus of claim 1, wherein the conduits, when coupled to the first and second openings in the first and second manifolds, are configured to have an average spacing between the conduits of between 0.1 inches and 1.5 inches, and wherein the conduits have a length between 30 inches and 70 inches.

9. The apparatus of claim 1, wherein the apparatus is configured to provide a surface area of exposed algae per cubic foot of at least 2500 square inches per cubic foot.

10. The apparatus of claim 1, further comprising at least one drain hole coupled to at least one of the passages.

11. The apparatus of claim 1, further comprising:
a fluid circulator coupled to the reservoir and configured to provide the fluid and feedstock to the conduits; and
a harvester in fluid communication with the conduits, wherein the harvester is configured to harvest a mass of biological organisms produced in the conduits.

12. The apparatus of claim 11, further comprising a housing, wherein the conduits, the first manifold, the second manifold, the reservoir, and the harvester are located in the housing.

13. A method for growing biological organisms, comprising:
flowing fluid and feedstock for growth of biological organisms through a plurality of transparent conduits, wherein the conduits are coupled between a first manifold having a plurality of first openings that receive first ends of the conduits and a second manifold having a plurality of second openings that receive second ends of the conduits, the first manifold including a plurality of first passages in fluid communication with the first openings and the second manifold including a plurality of second passages in fluid communication with the second openings, and wherein the fluid and feedstock flow in series through the plurality of conduits between an inlet coupled to a first conduit in the plurality of conduits and an outlet coupled to a last conduit in the plurality of conduits;
providing light at a wavelength between 100 nm and 700 nm to the conduits; and
harvesting a mass of biological organisms produced in the conduits.

14. The method of claim 13, further comprising providing the fluid and feedstock to the conduits from a reservoir coupled to the conduits.

15. The method of claim 14, further comprising circulating the fluid and feedstock through the conduits and the reservoir.

16. The method of claim 13, further comprising generating the flow of the fluid and feedstock from the first conduit of the plurality of conduits to the last conduit of the plurality of conduits using a pump coupled to at least one of the plurality of conduits.

17. The method of claim 13, further comprising flowing the fluid and feedstock from a first conduit to a second conduit through at least one of the first or second passages.

18. An apparatus for growing biological organisms, comprising:
a plurality of transparent conduits;
a light source configured to provide light at a wavelength between 100 nm and 700 nm;
a first manifold that includes a plurality of first openings configured to receive first ends of the conduits, wherein the first manifold includes a plurality of first passages coupled to the first openings, the first passages providing fluid communication between the first ends of a pair of conduits;
a second manifold that includes a plurality of second openings configured to receive second ends of the conduits, wherein the second manifold includes a plurality of second passages coupled to the second openings, the second passages providing fluid communication between the second ends of a pair of conduits; and
a reservoir in fluid communication with the conduits, wherein the reservoir is configured to provide fluid and feedstock for growth of biological organisms to the conduits;
wherein the first passages and the second passages are aligned such that fluid enters the apparatus through a first conduit, flows through the conduits in series, and exits the apparatus through a last conduit.

19. The apparatus of claim 18, wherein the apparatus is configured to provide a surface area of exposed algae per cubic foot of at least 2500 square inches per cubic foot.

20. The apparatus of claim 18, wherein the conduits, when coupled to the openings in the manifolds, are configured to have an average spacing between the conduits of at most 1.5 inches.
